(19) United States
(12) Patent Application Publication
(10) Pub. No.: US 2011/0276338 A1
(43) Pub. Date: Nov. 10, 2011

(54) AUTOMATED WORKFLOW ENGINE IN A DELIVERY OF HEALTHCARE

(75) Inventors: Adrian Warner, Wauwatosa, WI (US); Crispian Sievenpiper, Pewaukee, WI (US); Claudio Mejia, Wauwatosa, WI (US); Daniel Nowicki, Wauwatosa, WI (US); Sundararaj Mani, Waukesha, WI (US)

(73) Assignee: GENERAL ELECTRIC COMPANY, Schenectady, NY (US)

(21) Appl. No.: 12/773,193

(22) Filed: May 4, 2010

(51) Int. Cl. G06Q 50/00; H04Q 5/22; G06F 3/00; G06Q 10/00; G06F 15/16; G06F 3/048

(52) U.S. Cl. 705/2; 709/219; 715/772; 715/810; 710/19; 340/10.1

(57) ABSTRACT

Systems and methods for tracking the real-time progress of a medical workflow are provided. In one embodiment, a method includes receiving in a data processing system locations of a plurality of objects from a location system and determining in near real time whether the real-time locations indicate that a predetermined workflow has progressed from a first stage to a second stage using the data processing system.

### BACKGROUND

The subject matter disclosed herein relates to tracking stages of a workflow in a medical facility and, more particularly, to tracking stages of a workflow based on real-time locations of medical facility patients, equipment, and staff

Many specific processes are employed by the healthcare industry, generally described as care plans, to ensure that patients receive care according to certain predefined workflows. Because such workflows typically involve a patient in a medical setting, it may be difficult to track the various processes that may involve a patient. By way of example, hospital process compliance may be managed through paper checklists and/or manual-entry electronic recording tools. However, existing techniques for managing the progress of workflows may progress only after certain medical staff have indicated that the workflow has progressed, which may result in added labor costs and may distract medical staff. Further, with the existing techniques, workflow progress may be updated only when entered manually and, as such, may be imprecise.

### BRIEF SUMMARY

Certain aspects commensurate in scope with the originally claimed invention are set forth below. It should be understood that these aspects are presented merely to provide the reader with a brief summary of certain forms various embodiments of the presently disclosed subject matter might take and that these aspects are not intended to limit the scope of the invention. Indeed, the invention may encompass a variety of aspects that may not be set forth below.

In one embodiment, a method includes receiving in a data processing system locations of a plurality of objects from a location system and determining in near real time whether the real-time locations indicate that a predetermined workflow has progressed from a first stage to a second stage using the data processing system.

In another embodiment, a method includes ascertaining locations for objects in a medical facility at a first time using a real-time location system, ascertaining locations for the objects at a second time using the real-time location system, determining in near real time whether the locations ascertained at the first time and the second time match a predetermined condition, and indicating that a workflow has progressed from a current stage to a next stage when the predetermined condition is met.

In another embodiment, a system includes a memory device having a plurality of routines stored therein and a processor configured to execute the plurality of routines stored in the memory device. The plurality of routines includes a routine configured for receiving real-time location data for objects at a first time, a routine for receiving real-time location data for the objects at a second time, a routine for determining whether the real-time locations for the objects ascertained at the first time and the second time match a predetermined condition, and a routine for outputting an indication that a workflow has progressed from a current stage to a next stage when the predetermined condition is met.

Various refinements of the features noted above may exist in relation to various aspects of the subject matter described herein. Further features may also be incorporated in these various aspects as well. These refinements and additional features may exist individually or in any combination. For instance, various features discussed below in relation to one or more of the illustrated embodiments may be incorporated into any of the above-described embodiments of the present disclosure alone or in any combination. Again, the brief summary presented above is intended only to familiarize the reader with certain aspects and contexts of the subject matter disclosed herein without limitation to the claimed subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 shows a schematic diagram of an embodiment of a system in accordance with the subject matter described herein;

FIG. 2 shows a schematic diagram of another embodiment of a system in accordance with subject matter described herein;

FIG. 3 illustrates another embodiment of a system in accordance with the subject matter described herein;

FIG. 4 shows an embodiment of an information package or packet generated by the system of FIGS. 1-3.

FIG. 5 shows a schematic flow diagram of an embodiment of a method of operation of the system of FIG. 1 in accordance to the subject matter described herein.

FIG. 6 illustrates an embodiment of a subscriber user interface in accordance with the subject matter described herein.

### DETAILED DESCRIPTION

One or more specific embodiments of the presently disclosed subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present techniques, the articles “a,” “an,” “the,” and “said” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Further, any use of the terms “top,” “bottom,” “above,” “below,” other positional terms, and variations of these terms is made for convenience, but does not require any particular orientation of the described components.

Furthermore, embodiments of the present techniques may involve the tracking of “objects,” which may refer to people (e.g., medical facility staff or patients), or objects (e.g., medical equipment or devices). The tracking device associated with an object may be referred to as a “tag,” which may include a badge, or any other suitable tracking device attached to, or otherwise associated with the object to be tracked.

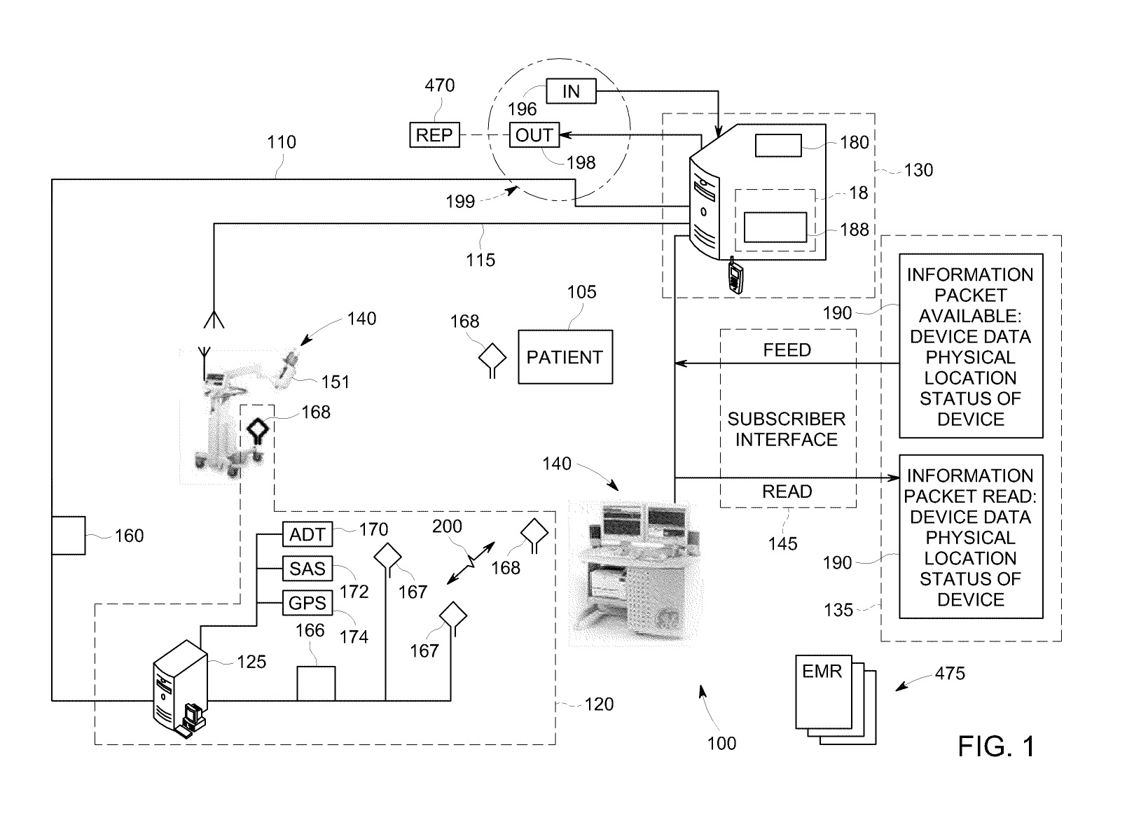

Referring to FIG. 1, an embodiment of a system 100 of the subject matter herein able to integrate data from disparate sources in the delivery of care to a patient 105 includes a network connection 110 (e.g., Ethernet) or a wireless network connection 115 (e.g., Wi-Fi) independent of or in combination with one another, a real-time location (RTLS) system 120, a RTLS server (may be software, hardware or combination thereof) 125, an information server (may be software, hardware, or combination thereof) 130, a master database 135, at least one object 140 to track with the RTLS system 120, and a subscriber interface 145 to feed data and communicate data from the master database 135.

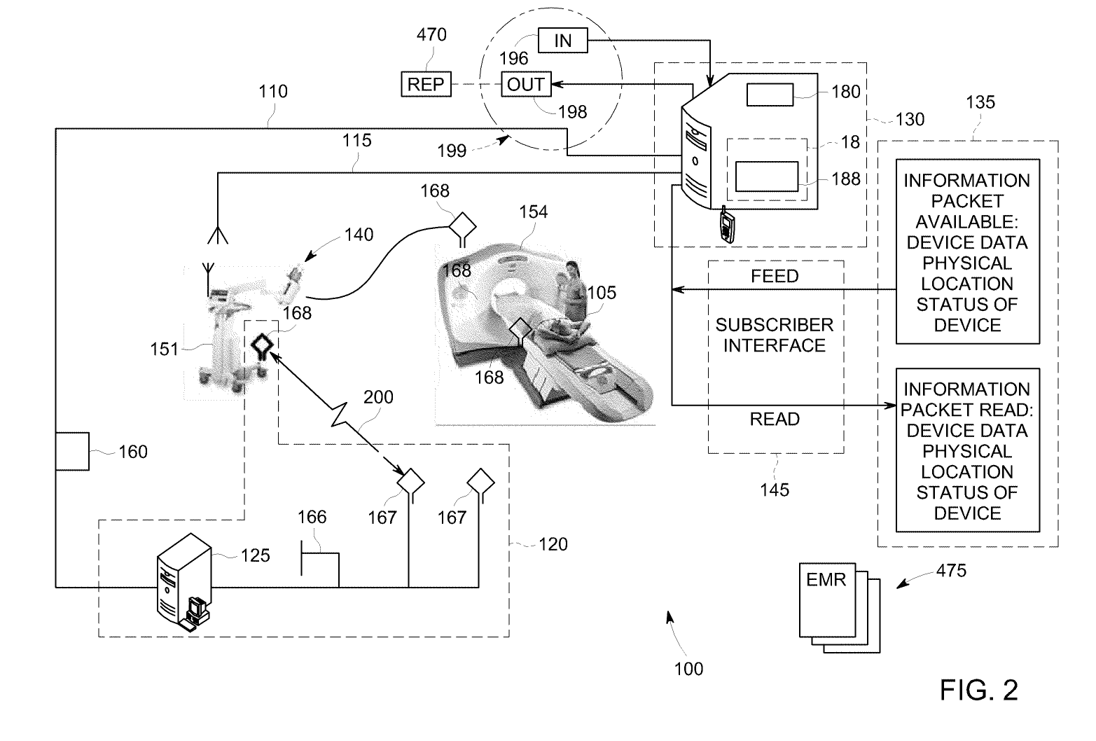

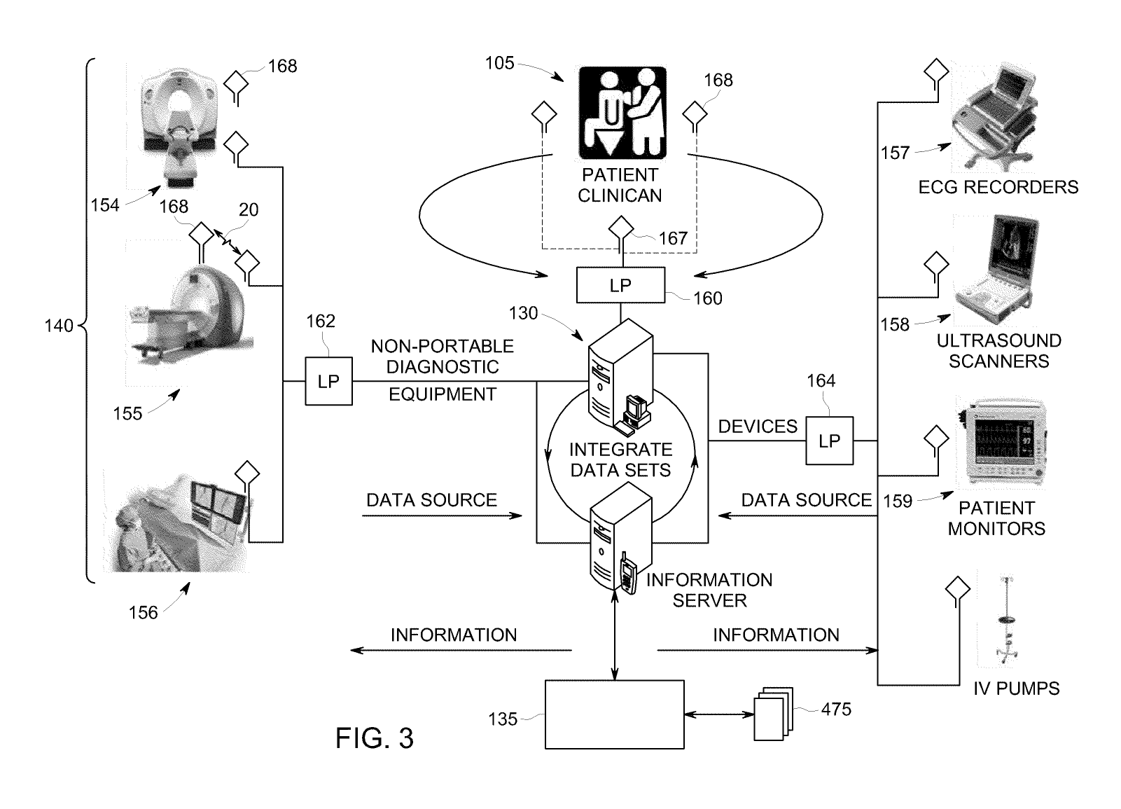

Objects 140 as referred to herein may refer to people (e.g., medical facility staff or patients), or medical equipment or devices. One embodiment of the system 100 can be operated or employed in combination with one or more objects 140 in a single location or at multiple, independent locations. Referring to FIG. 1, for example, one object 140 can include a pump 151 and a hemodynamic recorder 152 that can be of shared use across multiple laboratories (e.g., catheter laboratories). Less than the multiple objects 140 may not be used, or objects 140 may be relocated. The concept described is not limited to one modality. Rather, numerous topologies exist with a multiplicity of objects 140 (e.g., measurement devices, diagnostics systems, processes and procedures). For example and referring to FIG. 2, the object 140 can include the pump 151 in combination with a CT imaging system 154 to communicate source data covering the number of procedures performed on the patient 105. In other example and referring to FIG. 3, the object 140 can include the CT imaging system 154 in combination with an MR imaging system 155, an angiography imaging system 156, an ECG recording system 157, a ultrasound imaging system 158, and a patient monitor 159. A CT system 154 can receive information about the patient and actions taken on the patient in the scanning room (for example IV infusion pump information). The number and type of objects 140 can vary and is not limiting.

An embodiment of the RTLS server 125 can receive an identification and operation parameters (including equipment type, status, and location) of the objects 140. The RTLS server 125 may or may not cover a non-mobile device (ie fixed installations such as the CT scanner 154) because their physical disposition can already be understood. Yet, the RTLS server 125 may track the status or operation parameters of the non-mobile devices 154. An identity of each of the objects 140 can be registered at the RTLS server 125 so as to have its location tracked by the RTLS system 120.

According to one embodiment of the system 100 as shown in FIG. 3, the real-time location system (RTLS) 120 can include multiple location providers 160, 162, 164 to provide location data signal 166 to the RTLS server 125. The acquired location data associated with the object 140 can be communicated between a detector (e.g. beacon, receiver or transceiver) 167 with a “tag 168” (e.g. a badge), or any other suitable tracking device attached to, or otherwise associated with a unique identification or classification of the object 140 to be tracked. The types of location tracking system 120 can include radio frequency (e.g. high frequency (HF), ultra-high frequency (UHF) spectra) infrared (IR), optical scanning of a bar code or optical marker or shape recognition, etc. or combination thereof.

The location data signal 166 acquired by the RTLS system 120 may include a raw data feed of real-time location data and/or location history for one or more RTLS tags 168, which may be associated with the objects 140 (including patients, equipment, or staff). The location data 166 may include an assertion of a patient location, such as a direct-entered manual location or data stream integrated location messages. By way of example, an admissions/discharge/transfer (ADT) system (e.g., a bed placement system) 170 may provide such an assertion of a patient location, such as a particular bed in which a patient 105 is assigned. Referring to FIG. 1, other location providers 170, 172, 174 may provide additional location data to supplement the RTLS system 120, and may include, for example, a security access system 172 that controls access to locations within the medical facility, a GPS tracking system 174 that employs the Global Positioning System (GPS) for indoor or outdoor tracking of patients 105, equipment, and/or staff.

Referring to FIGS. 1 thru 3, the information server 130 can include a program memory 180 with software module of program instructions for execution by a processor 182 alone or in combination with other hardware, including the multiple location providers 160, 162, 164, 170, 172, 174 and RTLS systems 120. An embodiment of the information server 130 can include an aggregator 188 operable to verify the information or data, as well as to read the information or data communicated or fed from the multiple servers (e.g., RTLS server 125). The aggregator 188 can be operable to store the acquired feed of information or data in the master database 135, as well as regulate access thereto. An embodiment of the aggregator 188 can be such that any user can interface with, as well as the multiple servers 125. The aggregator 188 can automatically perform periodic or continuous checks to receive the feed of status or updates to the information or data of the object 140 as acquired at the multiple location providers 160, 162, 164, 170, 172, 174 of the RTLS system 120.

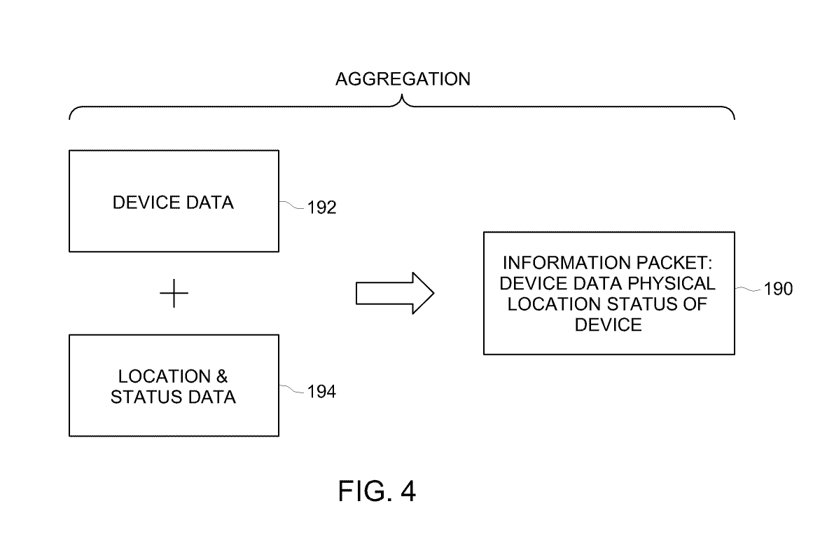

Referring back to FIGS. 1 and 2, an example of the aggregator 188 can combine the information about the one or more objects 140 received from the RTLS server 125. Referring to FIG. 4, the information server 130 can translate received data or information into a common or uniform format, as well as combine or aggregate the data or information to create an information data packet 190. For example, the aggregator 188 can receive a first data packet or stream 192 that includes device data (e.g., object name or identification, operating parameters, classification of object 140, calibration data, selected passive data, etc. of the object 140) and a second data packet or stream 194 that includes location and status data of the object, translate the first and second data packets 192 and 194 into a common format so as to combine or aggregate the first and second data packets 192 and 194 into a third data packet (herein the information package) 190 that can include device data, physical location and status of the device, and store the third data packet 190 in the data base for searching and access by the information server 130. The information server 130 can publish this information package 190. Once published, subscribers to the system 100 can collectively or independently access or receive the information package 190. The information server 130 can handle aggregation of data tasks, and can minimize load of information.

One embodiment of the information server 130 may perform various techniques to map the location per acquired location data signal 166 to predetermined object types and/or predetermined discrete/defined areas. The information server 130 may similarly perform various techniques to map or create directions from the raw location data 166 received from the RTLS system 120, to the predetermined discrete areas in conjunction with the RTLS server 125. The RTLS server 125 may perform various techniques to translate raw location data signals 166 from the one or more RTLS systems 120 into a format that may be calculated upon in real-time to ascertain associations between objects 140 based on location. The various techniques performed by the RTLS server 125 may include, for example, techniques for resolving the location of the tag 168 based on signal strength and/or mapping of the received location per the location data signal 166 relative to predetermined object types. After processing the location data signal 166, the RTLS server 125 may output the location of the respective object 140. Among other things, the location may include the discrete current locations of identified objects 140 and/or tags 168 associated with objects 140 (e.g., specific predetermined areas of a medical facility).

The embodiment of the information server 130 can include modules of computer readable program instructions to process the location data signal 166 or location into a format that may enable the determination of meaningful associations between tracked objects 140 (including patients, equipment, and staff) in real-time and the association type. An association can be defined as a calculation of an interaction of one or more objects 140 with one or more of a predefined space or location or other objects 140. The calculation information of the association between objects 140 can be used to bill customer, to initiate an event, to calculate an inventory of objects 140 available and unavailable for use, to study utilization of objects 140, etc. Discerning certain associations may involve reviewing the historical location of objects 140, so the location per the signal 166 may be stored as it arrives at the information server 130. The information server 130 may also store the various associations of objects 140 with the location data 166 in the master database 135.

An embodiment of the processor 182 can be a central processing unit (CPU), which may execute various routines and processing functions of the system 100. For example, the processor 182 may execute various operating system program instructions as well as software routines configured to effect certain processes and stored in a computer readable-medium, such as the memory 180 (e.g., a random access memory (RAM) of a personal computer or one or more mass storage devices such as an internal or external hard drive, a solid-state storage device, CD-ROM, DVD, or other storage device). In addition, the processor 182 can process acquired data for input to various routines or software programs, such as data provided as part of the present method and techniques in computer-based implementations.

The processor 182 may be in communication with one or more input devices 196 and output devices 198. The input devices 196 may include manual input devices, such as a keyboard, a mouse, or the like. In addition, the input devices 196 may include a network device, such as a wired or wireless Ethernet card, a wireless network adapter, or any of various ports or devices configured to facilitate communication with other devices via any suitable communications network, such as a local area network or the Internet. Through such a network device, the system 100 can exchange data and communicate with other networked electronic systems, whether proximate to or remote from the system 100. The network device or communications network may include various components that facilitate communication, including switches, routers, servers or other computers, network adapters, communications cables, and so forth.

Results generated by the system 100, such as the results obtained by processing data in accordance with one or more stored routines, may be provided to a client (e.g., operator or end-user) via the one or more output devices 198. Based on the displayed or printed output, an operator may request additional or alternative processing or provide additional or alternative data, such as via the input device 196. Communication between the various components of the system 100 can be accomplished via one or more chipsets or busses or interconnects which electrically connect the components of the system 100. In certain embodiments of the present technique, the system 100 may be configured to refine real-time measurements of tags 168 used by one or more real-time location system and/or to determine meaningful relationships between patients, equipment, or staff by processing location data in real time or near real time from one or more location tracking systems. As used herein, “real-time” can generally mean without delay, given the processing limitations of the system and time required to actually measure the data.

Referring to FIGS. 1 and 2, an embodiment of the input device 196 and output device 198 can be combined as part of a user interface 199 in communication with the information server 130 and the master database 135 having access to the acquired information or data, including current and historical locations, availability or workflow states of objects 140 including the patients, equipment, and/or staff, as well as associations of statuses or events calculated therefrom) from the information server 130 for visualization or display at the interface 220.

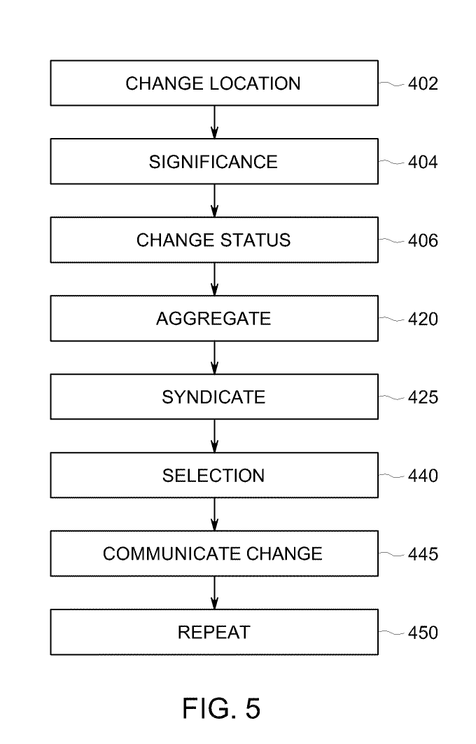

Having generally provided the above-description of a construction of the embodiment the system 100, the following is a general description of a method 400 of operation of the system 100. It should also be understood that the sequence or succession of the acts or steps of the method 400 (See FIG. 5) as described in the foregoing description can vary. Also, it should be understood that the method 400 may not require each act or step in the foregoing description, or may include additional acts or steps not disclosed herein. One or more of following steps and acts of the method 400 can also be in the form of a computer program product having modules or zones or computer-readable program instructions that can be stored on the computer readable medium or memory 180 for execution by the processor 182, and which can be located or be integral at least in part with the program memory in communication with the processor 182 described above or be independent thereof.

Assume for sake of example that tracking the location of the objects 140 in the medical facility may be based on the location of the tag 168 associated with each the object 140. The RTLS system(s) 120 may generate the location of the object 140 when the signal 166 is transmitted by the tag 168 and received by the detector 167 in the RTLS system(s) 120. The location of tags 168 may be saved to RTLS server 125 in the location tracking system 120. A communication between the tag 168 and the detector 167 in the medical facility can be received by the system 120. A communication may refer to a transfer of signals between the tag 168 and one or more detectors 167. In embodiments, the tag 168 may transmit a wireless signal, and depending on the type and strength of the signal, one or more detectors 167 in the medical facility may receive the signal.

Each tag 168 in the medical facility may be registered in the RTLS system 120, the RTLS server 125 or the information server 130. However, if the identity of a signal received by the detector 167 is not known, the location tracking system 120 may not recognize the tag 168 transmitting the signal. If unidentified, the RTLS system 120 may create a new identification for the received signal, or register the signal as a new tag in the system 120. In some embodiments, updating the location of the tag 168 may be based on the location of detectors 167 communicating with the tag 168. For example, multiple detectors 167 may be placed at known locations throughout the medical facility. As a communication between the tag 168 and the detector 167 may occur when the tag 168 is within a certain proximity to the detector 167, a communication may indicate that the tag 168 is at or near the location of the detector 167. When the tag 168 communicates with the detector 167, the signal may be sent from either the tag 168 or the detector 167 to the RTLS server 125 or RTLS system 120. The signal 166 may indicate location data of the detector(s) 167 communicating with the tag 168, and may determine the location of the tag 168 based on the identification or location of the detector 167 communicating with the tag 168. In embodiments, location data may be provided in varying levels of specificity, including rooms or defined spaces in the medical facility, x-y coordinates, etc. Further, in some embodiments, the signal 166 received by the RTLS system 120 may also provide information in addition to location data. For example, the signal 166 may indicate whether the object 140 associated with the tag 168 is on or off, or other Boolean information regarding the status of the object 140. The signal 166 may also indicate other attributes of the object 140, such as temperature or pressure, other information which may be in a numerical range, manufacturer data, and so forth.

In some embodiments, the RTLS system 120 may not recognize the location of the detected signal 166, if, for example, detectors 167 are not associated with any particular location. When the location of the received signal 166 is not known, the RTLS system 120 may create a new location. In embodiments, the location may be created based on an existing map of the medical facility, x-y coordinates, or any other location marker.

The method 400 may include a step 402 of calculating whether the detected signal 166 indicates a change in location of the tag 168. A change in location may be based on the most recently detected location of the tag 168. In some embodiments, determining a change in tag location may be based on current location data, or continuously detected location data. For example, “current location data” may be continuously or passively collected for each tag 168, regardless of whether a change in location is detected. This current location data may accessible by the RTLS server 125 and used to determine whether a change in location has been detected. The RTLS server 125 may compare the currently detected location with the previously detected location from the current location data to determine whether a change in location has been detected. A detected change in the location may not necessarily mean that the tag 168 has actually changed in location. As will be discussed, a detected change in location may result in further analysis or processing by the location RTLS system 120 to determine whether the detected change is an actual change in location.

If a change in location is detected, the RTLS system 120 or RTLS server 125 can update the location of the tag 168. In updating the tag location, the RTLS system 120 or server 125 new location of the tag 168 in the tag location “history,” which may refer to any recorded location data corresponding to the tag 168 or the object 140. The history may be a log of location data for the tag 168, or the object 140 associated with a tag 168, and may be stored in the RTLS server 125, information of the system 100. A user via the input device 196 or output device 198 or interface 199 may be able to access the history to obtain location data of the tags 168 or objects 140 in the medical facility. If a change in location is not detected, the location may not be updated to the tag location history, but may still be updated as current location data, which may be used to determine whether a change in location has been detected.

In some embodiments, the location of the object 140 (e.g. medical equipment or a person) may be tracked in the medical facility by associating the object 140 with the tag 168. As discussed, the tag 168 may be assigned to or associated with the object 140, and the RTLS system 120 may determine the location of the object 140 based on the location of the tag 168. Once the tag location has been detected and/or updated, the RTLS system 120 may determine whether the object 140 has been associated with the tag 168. If the object 140 is associated with the tag 168, then the RTLS system 120 or server 125 may update the location of the associated object 140.

Determining whether a new location has been detected may be based on a comparison of the currently detected location with the previously detected location of the tag 168 or object 140.

The step 402 of calculating whether there is a change between the previously and currently detected locations and may include detecting a change in the communication between the tag 168 and one or more detectors 167 of the RTLS system 120. For example, the tag 168 associated with the object 140 may communicate with detector 167, and may detect a new location of the object 140 when the one detector 167 no longer receives a signal 200 and/or another detector 167 begins to receive the signal 200. In one embodiment, the tag 167 may transmit the wireless signal 200 which is received by one or more detectors 167, and may detect a change in location if the signal 200 received by the detectors 167 changes in strength or intensity, or if the signal 200 is received by a different detector(s) 167.

If a change in location is detected, the step 402 can also include calculating whether the change exceeds a “movement threshold”. As used herein, a movement threshold may refer to any parameter used to determine whether the tag 168 or associated object 140 has moved. As will be discussed, in some embodiments, the movement threshold may include time duration that a change in location is detected, or a comparison of the signal strengths of communications detected. The threshold may be determined based on whether the tag 168 being tracked is associated with the object 140, and may further be based on the type of object 140 or status of object 168 being tracked. For example, a wheelchair may have different movement threshold parameters than a walker or a person, as each may move with different speeds. The movement threshold may reduce the number of location data entries to the tag 168 or object location history and may further improve the quality of location data by not recording location data which may not accurately reflect the actual location of the object 140. If the RTLS system 120 determines that a new location is detected, and the change in location exceeds a movement threshold, the RTLS system 120 may then update the location history.

The step 402 can include detecting whether a history exists for the object 140. A tracked object 140 may not have an existing history if, for example, the object 140 is new to the system 100, or the tag 168 is recently assigned to the object 140. If no history exists, the RTLS system 120 or information server 130 may insert a history for the tracked object (block 88). The history for the tracked object 140 would then have the most recent location data corresponding to the object 140. If a history exists for the tracked object 140, the RTLS system 120 may update the history to reflect the most recent location data, or the change in the location of the object 140. In some embodiments, an update may also be made to the continuously collected current data of the object 140 such that the current data may be updated.

The step 402 can include calculating whether a new location is detected based on the history of each tag 168 or object 140. A location of the object 140 may be recorded to the object location history only when a change in location is detected. This may further reduce processing complexity and save space in the system 120 or server 125 or information server 130 or master database 135. Furthermore, in accordance with the present techniques, the method 400 may be continuous, and may include constantly or regularly monitoring the signals detected by detectors 167 and/or tags 168 in the system 120 to determine if and when a change in location is detected.

While the present disclosure may refer to the location tracking of tags 168, it should be understood that any of the tags 168 mentioned herein may be associated with the object 140, and tracking the location of the tag 168 may result in determining the location of the object 140.

The signals 200 detected by detectors 167 in the RTLS system 120 may depend on a number of factors, including the movement of the object 140 to which the tag 168 is attached, the type of object 140 or condition of object 140 to be tracked, the type of signals transmitted and received, the placement of the detectors 167 in the medical facility, and the frequency of signal detections.

The tag 168 may move throughout the medical facility, and the location of the tag 168 may be updated based on the movement. In some embodiments, location updates may be made periodically or continuously.

Once a detection count or duration of the detected new location is obtained, the method 400 may include calculating whether the detection count or the duration exceeds a threshold. This analysis may be a type of movement threshold. For example, the threshold may be set to a certain number of detection counts, or a certain time duration, and if the detection count or duration obtained exceeds the threshold, the method 400 may include calculating that the detected change in location is an actual change in location. If the tag 168 pauses in a location for a length of time to reach a duration or a number of detection counts to exceed the threshold, the RTLS system 120 may proceed with updating the location of the tag 168 or object 140. If the detection count or duration does not exceed the threshold, the RTLS system 120 may not make an update to the location history of the tag 168.

If the detection count or duration exceeds the threshold, the method 400 can include verifying the new detected location. For example, in one embodiment, the verification may include comparing the new detected location with a previous location to determine whether the change in location is probable, or possible, based on the structure of the medical facility. The verification analysis may reduce the recording of improbable or impossible location changes across medical facility boundaries, further improving the quality of location data.

The location history of the tag 168 or object 140 may also be updated. While the update may be made to the location history of the tag 168 or object 140, the location data may also be used to determine the location of object 140 associated with the tag 168, and a history update may also be made for the associated object 140. The history updates for tags 168, or for associated objects 140, may also be made to the information server 130 and database 135 in the system 100. Current data may be collected passively, or continuously, regardless of whether changes in location have been detected.

One embodiment of the calculating step 402 can include calculating the location data of the tag 168 based on the signal strength intensities (SSIs) of the communications 200 between the tag 168 and the detector(s) 167 communicating with the tag 168. The SSI may refer to a strength or intensity of the communication 200 between the detector 167 and the tag 168. For example, a stronger communication (i.e., a higher SSI) may indicate that the tag 167 is closer to the detector 167 than a weaker communication (i.e., a lower SSI).

Depending on the configuration of a medical facility, or a floor plan of the medical facility, the RTLS system 120 may be able to verify a location change based on the likelihood of certain changes in location. In one embodiment, a location change may be verified to prevent the location from “jumping” from area B, through an unavailable space, to area E. The RTLS system 120 may be configured to decide that a location change between areas B and E is unlikely, or impossible because the tag 168 or object 140 cannot travel from area B to area E in a certain amount of time. The verification may be based on one or more parameters, such as the distance of the possible routes from area B to area E, and the amount of time reasonable to travel this route (e.g., based on average travel speed of the object 140 associated with the tag 168, such as a walking speed of a person). In some embodiments, if a new location is not verified, the new location may not be recorded or updated.

Verifying the location may also depend on whether the tag 168 being tracked is associated with the object 140, and may also be based on the type of object 140, or the condition of the object 140 being tracked. For example, in determining reasonable travel times between various areas of the medical facility, the RTLS system 120 may perform a verification analysis based on customized speed estimations of the object 140 associated with the tag 168.

As noted above, the type of the object 140 associated with the tag 168 may be a factor considered in decisions carried out in the method 400 described above. Additionally, it should be understood that the RTLS system 120, may provide locations associated with objects 140 of certain types (e.g., patient 105, equipment, staff, etc.). By way of example, such object types may be described in an object type hierarchy. The object type hierarchy may encompass all object types, relating the various object types by inheritance. Thus, all objects 140 of the object type hierarchy may inherit from a global parent, which may have a parent-child relationship to such object categories as patients 105, equipment, and staff of the medical facility. The object categories may respectively have parent-child relationships to third-level object types, each of which may respectively have parent-child relationships to fourth-level object types. By way of example, in the exemplary object type hierarchy, the fourth-level object type “surgeon” may inherit from the global parent “all items,” the object category “staff,” and the third-level object type “clinical.” The particular type of the object 140, as described in the exemplary object type hierarchy, may enable meaningful real-time processing, as described further below.

Discrete locations in the medical facility where objects 140 and/or tags 168 may be located may be described in a similar manner to that of object types, as illustrated by an exemplary discrete location hierarchy. The exemplary discrete location hierarchy may describe the geometry of the medical facility using inheritance-based relationships to relate all possible discrete locations of the medical facility. As such, the medical facility may have a parent-child relationship with floors, which may in turn have respective parent-child relationships with departments. The departments may have respective parent-child relationships with room categories, each of which may have respective parent-child relationships with individual rooms. When such rooms are further subdivided in the medical facility, the rooms may have respective parent-child relationships with beds or bays.

If the object 140 has changed locations step 404 can include calculating a significance or threshold behind the change in object location. A change in object location from one discrete location to another discrete location may indicate that a meaningful event is taking place in the medical facility. The tracked status of each of the objects 140 may be compared to predetermined workflow rules (e.g., a status rules). For example, the workflow rule may define a status of each object 140 based on an association with the other objects 140 in the same discrete location. The predetermined workflow rule may indicate that, when a nurse moves from a room where a first patient 105 is in bed to another room where a second patient is in bed, the status of the first patient may be “in bed,” while the status of the second patient may be “with nurse,” based on the association, or lack thereof, with certain other types of objects 140.

If detection of a meaningful event to the first object 140 occurs, and the step 404 of detecting a meaningful event can trigger step 406 of changing a status of the first object 140. Then the system 100 can re-classify and store the original status of the first object 140(e.g. “at nurse station”) at the database 135 as a historical status of the first object 140. Thereafter, the system 100 can continuously or periodically update the status of the first object 140 to be classified and stored as a new status of the first object 140 (e.g., “with patient”), as defined by the predetermined workflow rule and to be distinguished from the historical status of object 140. If additional objects 140 remain to be considered, the next object 140 may be considered, and the steps may repeat.

In response to detection of an event or combination of events, the system 100 may consider a request generated in response to a predetermined workflow rule that may trigger a start of a predetermined workflow. An example of an event or combination of events that can trigger a predetermined workflow rule may be detection of a change in patient status event occurring when a patient and nurse enter an operating room, and the predetermined workflow rule may be to cause or trigger the progress of a patient surgery workflow to a subsequent stage under such conditions. In executing a predetermined workflow rule, a particular workflow (e.g., medical procedure such as diagnosis or treatment) may be progressed from a current stage or status (e.g., patient ready for surgery) to a next stage or status (e.g., patient in surgery). Predetermined workflow rules may include consideration of other objects 140 co-located in a discrete location, the prior discrete locations of such objects 140, object statuses, the length of time the object 140 has remained in a particular discrete location, etc.

The method 400 can include the step 420 of aggregating the acquired data from the objects 140 in communication with the information server 130. An embodiment of the step 420 of aggregating can include executing software instructions to filter and arrange the acquired data into the standardized information package or packet 190 (see FIG. 4) representative or correlated to an individual, category or class of objects 140. One embodiment of the standardized information package 190 can include a consistent format of type and arrangement of data content. An example of the format of the information package 190 can include a unique identification of the individual, category or class of object 140, along with a physical location and a status of the individual, category or class of object 140. Yet the format and content of the information package 190 can vary. The step of aggregating can further include updating the content of each information package 190 maintained for an individual, category or class of objects 140 in response to the detecting step 406 of changing the status associated with the individual, category, or class of objects 140, while maintaining in memory storage 180 the historical content of the respective information package 190.

Step 425 can include syndicating the information packages or packets 190 to via the information server 130. Syndicating as used herein can generally refer to the technique or method of publishing or communicating frequently updated information in a standard format to one or more subscribers to the system 100. One embodiment of the step 425 of syndicating can include execution of a real simple syndication (RSS) model or technique represented as programs instructions and/or hardware technology or combination thereof to streamline communication or feed of changing acquired data (e.g., to the information package including information of status, location, availability, function, etc.), such as via network connection 110 with the RTLS system 120 and multiple location providers 160, 162, 164, 170, 172, 174.

For example, the step 425 of syndicating using the RSS model described above can include a step of publishing the information packages or packets 190 of individual, categories, or class of objects 140 at the subscriber interface 145 for viewing by a user. An embodiment of the subscriber interface 145 can include multiple interfaces 145 located at nurse workstations, at selected objects 140 in communication with the information server 130, as well as at a central workstation. The step of syndicating can include publishing the updated information packages or packets for simultaneous display at multiple subscriber interfaces 145 for simultaneous viewing by multiple users in general real-time with updates to the content in the information package or packets 190.

The step 425 of syndicating can further include receiving and publishing the request to schedule one or more objects 140 for use at a desired location in general real-time. The step of publishing the request can include simultaneous display of the request at multiple user interfaces 199 for simultaneous viewing by multiple users in general real-time upon creating or receiving of the request at one of the multiple subscriber interfaces 199.

The step 425 of syndicating can further include filtering of the publication or display of the information packages 190 in response to the request at the one of the multiple user interfaces 199. The step of filtering in response to the received request can include detecting, from the publication of the information packages 190 of individual, categories, or classes of objects 140, the information packages or packets 190 including an indication or data representative of a current available or ready status. Filtering can further include displaying of the detected information packages or packets 190 having data representative of a current available or ready status for illustration at the one of the multiple user interfaces 190 where the request was created or submitted.

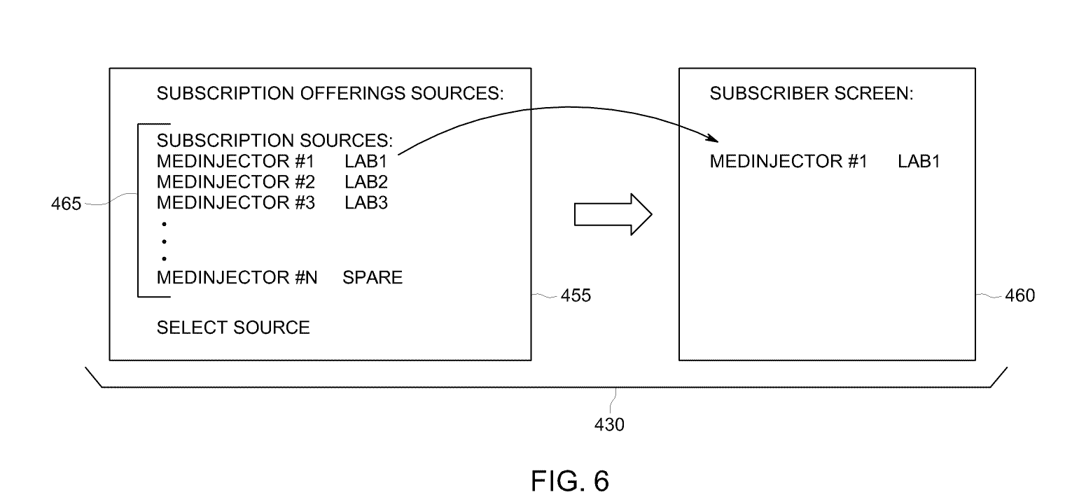

The step 425 of syndicating can include illustrating a display 430 (see FIG. 6) of a list of unique identification and relative location or distance of the individual, category or class of objects 140 as listed in the information package or packets 190 having a current available or ready status compared to the location of the one of the multiple user interfaces 199 where the request was created or received or per a location listed in the request. The display 430 of the relative location or distance can include an illustration of an order from closest to farthest of location or distance of the individual, category or class of objects 140 relative to the location of the one of the multiple user interfaces 199.

Referring back to FIG. 5, step 440 can include receiving instructions of a selection of one of the multiple objects 140 having a current availability or ready status. An embodiment of step 440 can include automatic identification and selection of one of the multiple objects 140 having current availability or ready status and having a location closest to the designated location in the request.

Step 445 can include automatically communicating to the information server 130 to change the current availability or ready status of the selected object 140 per the instructions received in step 440. Step 445 can include the information server 130 automatically updating or changing the information package 190 of the respective object 140 selected in step 440 per the received instructions, so as to update the status of the respective object 140 to indicate unavailable or non-ready status.

Step 450 can include repeating the step of syndicating so as to publish the update to the information package or packet 190 of the respective object 140 selected per the instructions received in step 440.

Referring again to FIG. 6, an embodiment of the user interface 199 (See FIG. 1) created per execution of the above-described method 400 is shown. The embodiment of the interface 199 can include the display 430 comprising multiple display panes or windows 455 and 460. The display 430 can include a visualization of graphic representations 465 of a list of unique identification or category or class of objects 140 that subscribe with the information server 130 of the system 100 (e.g., objects that communicate data content of information packages or packets to information server). Display 430 can include illustration of graphic representations of the individual, category, or class of information sources or objects 140 per instructions of a predetermined workflow rule or per instructions received from a user at the user interface 199.

Display panes 455 and 460 may include graphic representations that upon selection or action can cause or trigger execution of additional functions. For example, a mouse click or user selection of one of the graphic illustration 465 of the unique identification of the objects 140 can trigger or create a display of the disposition or location of the subscribed data content in the information packages or packets 190 for the respective object 140. In the example of the object 140 being the Hemodynamic recording system 152 as shown in FIG. 1, the disposition of the data content might be included in a medical record 475 of the event or patient 105, or kept in an associated technical file to support case review in the instance of an adverse event. Additionally, the subscription data content might be integrated into a report 470 generated or created automatically per instruction of the user.

The system 100 can include safeguards, for example, to eliminate automated data collection from the object 140 that is no longer located at a point of care (i.e. physically removed from the procedure room) or is unavailable for use because either under repair or maintenance (e.g., in need of calibration) or cleaning. An embodiment of the system 100 can also be configured to create or cause an alert that the status or location of the object 140 has changed such that the information package or packet 190 is no longer valid after receiving selection instructions associated with the request. The system 100 can also generate visualization of a graphic representation of whether its current status or availability is feed is pull or push, and frequency of its data collection. The system 100 can further include graphic representations to prompt or receive user instructions of a manually defined frequency of frequency of or manual instruction to update acquisition of data content fed to the information server 130 from the objects 140 and location providers.

Still referring to FIG. 6, an embodiment of the user interface 199 can further include graphic representations to cause or trigger execution of additional functions of the system 100, including: a) graphic representation to execute automated information logging from other devices in the procedure room; b) graphic representation to execute creating new information relationships with objects 140 when collocated; c) graphic representation to execute breaking or interrupting an association or information relationships in response to detecting removal or movement of the object 140 from a location or space; and d) graphic representation to execute acquisition or requisition from the master database of complex information data sets or information packages or packets (i.e., Patient—Device type—dose delivered—time of delivery—date—etc.).

The embodiment of the program memory 180 of the information server 130 can be divided into several zones or modules, each module corresponding to a function or a mode of operation or steps of the method 400 described above. For example, the steps of method 400 can correspond to the implementation of one or more modules of computer readable program instructions by the processor 182, connected to the program memory 180 in which the module is stored, of all or part of the program instructions forming the module. Steps can be attributed to programs such that the steps can be executed by the processor 182, where the processor 182 can be controlled by instruction codes recorded in the program memory 180. The execution of the instruction codes can represent the means to carry out operations of the system 100. The discussion of the method 400 as described herein are for example illustration, and software program modules or zones operable to execute the method 400 can be unified or distributed according to constraints of size of the program memory 180 and the processor 182 and/or the speed of the processing operations desired.

A technical effect of the above-described system 100 and method 400 includes automatically calculating associativity of objects 140 with respect to location, user-controlled “information” syndication, automated data collection, an ability to provide basic physical error condition trapping and alerting (ie connected to wrong device in room), and providing informational subscription model level (e.g., content versa data integration) display to users.

The system 100 and method 400 of the subject matter described herein provide a combination of solutions to the problem of data association, and the concept of the system 100 configured use a subscription model to syndicate data information received from objects 140 in the delivery of healthcare to patients. The subscription model described as part of the system 100 and method 400 can provide for the conversion of data to the information package or packet 190 that can overcome issues with integration and dissemination in the medical environment, that can drive decisions automatically (e.g., to preclude access to inappropriate data helps prevent medical errors, and delays to procedures). The system 100 can provide the end-user with choices, flexibility and control to integrate acquired data in a client unique fashion. The system 100 and method 400 can also reduce overhead associated with validating integration of information from objects 140, and lower integration costs and overhead associated with objects 140 and location providers.

The system 100 and method 400 can include a user configuration where users can have an enhanced choice of where and how the data is integrated at the receiving device (ie report, screen, technical log and medical record for example.); can integrate new data sources (ie, objects 140) at the information server 130 and convert to real-time subscription feed of acquired data from subscribed objects 140; can minimize repeat validation of objects 140 by conversion of acquired data to the information package or packets 190; healthcare providers can easily test their integration to the objects 140 to the system 100; can provide support via the information server 130 to the plurality of objects 140 subscribed to the system 100; and can support subscription to a plurality of end users or clients.

The embodiment of the system 100 and method 400 can provide information to user in the same information format; can check for errors at the information server 130, rather than rely on the user; can define information models via the information server 130, consistent across divergent data sources or objects 140 or location providers 160, 162, 164, 170, 172, and 174. For example if one manufacturer uses one measure and another a different measure, the information server 130 can reconcile the difference to then source one type of measure as a uniform information source.

The system 100 and method 400 can isolate the subscriber interface 145 so as to independently manage the integration interfaces of the objects 140 and location providers with the information server 130. Further, the system 100 and method 400 can enable supply of stand-alone variants of the information server 130 to integrate or test with the objects 140. The system 100 and method 400 also can provide smoother and faster data assimilation. The ability to provide automated management of complex information sources (e.g., objects 140 or location providers) also minimizes potential complexity at the information server 130. The various interfaces 145 and 199 of the system 100 can communicate through a very high level that treats the aggregated data in a form similar to that of written text.

Highly integrated care activities such as catheterization procedures can benefit from the ability to assimilate information about operation of the equipment 151 and 152 supporting/interacting with the patient 105. The ease of assimilation can allow data collection, aggregation, and physical relationships to automatically be assembled without human interaction or data entry. The ability to assimilate information from a central source (e.g., the information server 130) through a simple “news feed” type syndication technique can provide a simple, robust method to integrate information into the procedure record or electronic medical record (EMR) 475 (See FIGS. 1 thru 3) at the time of delivery of medical care to the patient 105.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
receiving operating data from a plurality of objects and a location of the each of the plurality of objects from at least one location provider;
aggregating the acquired data from the plurality of objects and the at least one location provider at an information server into an information packet correlated to a respective one of the plurality of objects, wherein each information packet includes a status and a location of the respective one of the plurality of objects;
receiving a request for at least one of the plurality of objects; and
syndicating the information package for one or more of the plurality of objects as ready in response where the information package includes the status as ready for use;
receiving an instruction to select one of the one or more objects having the information package that includes the status as ready for use; and
communicating feedback to the information server to change the status of the selected one of the one or more objects so as to indicate not ready for use.

2. The method of claim 1, wherein the step of syndicating includes communicating the information package in a standard format to multiple subscribers to the information server.

3. The method of claim 1, wherein the objects are medical devices employed in the delivery of healthcare.

4. The method of claim 1, wherein the at least location provider includes a real-time location tracking system that includes an rf identification tag that moves with the object.

5. The method of claim 1, wherein the step of syndicating includes publishing the information package associated to each of the respective one or more of the plurality of objects to at least one subscriber interface for viewing by a user.

6. The method of claim 1, wherein the step of syndicating includes requesting an update to the status in the information package for each of the objects subscribing to the information server, the step of requesting an update to the status triggered in response to receiving the request.

7. The method of claim 1, wherein the syndicating step includes executing a real simple syndication (RSS) model represented as programs instructions to communicate a change to data of the information package via a network connection with the at least one location provider.

8. The method of claim 1, further comprising the steps of:
creating a display illustrative of a list of unique identification and relative location of one or more of the plurality of objects, the identification and relative location as stored in the information package having the ready status, and further including an indication of a comparison of a distance of the one or more of the plurality of objects to a desired location in the request.

9. The method of claim 1, wherein a predetermined workflow rule automatically triggers the request, and the request includes a predetermined list of one or more objects of the system to perform a predetermined workflow in a delivery of healthcare to the patient.

10. A system comprising:
a memory device having a plurality of routines stored therein;
a processor configured to execute the plurality of routines stored in the memory device, the plurality of routines to instruct the processor to execute the steps of
receiving a request for at least one of the plurality of objects, and
syndicating the information package for one or more of the plurality of objects as ready in response where the information package includes the status as ready for use,
receiving an instruction to select one of the one or more objects having the information package that includes the status as ready for use, and
communicating feedback to the information server to change the status of the selected one of the one or more objects so as to indicate not ready for use.

11. The system of claim 10, wherein the processor executing the step of syndicating includes the processor communicating the information package in a standard format to multiple subscribers to the information server

12. The system of claim 10, wherein the at least location provider includes a real-time location tracking system that includes an rf identification tag that moves with the object.

13. The system of claim 10, wherein the processor executing of the step of syndicating includes the processor communicating the information package associated to each of the respective one or more of the plurality of objects to at least one subscriber interface for viewing by a user.

14. The system of claim 10, wherein the processor executing of the step of syndicating includes the processor requesting an update to the status in the information package for each of the objects subscribing to the information server, the step of requesting an update to the status triggered in response to receiving the request.

15. The system of claim 10, wherein the processor executing of the step of syndicating includes the processor executing a real simple syndication (RSS) model represented as programs instructions to communicate a change to data of the information package via a network connection with the at least one location provider.

16. The system of claim 10, wherein the processor further executes the step of creating a display illustrative of a list of unique identification and relative location of one or more of the plurality of objects, the identification and relative location as stored in the information package having the ready status, and further including an indication of a comparison of a distance of the one or more of the plurality of objects to a desired location in the request.

17. The system of claim 10, wherein the processor executing the predetermined workflow rule automatically triggers the request, and the request includes a predetermined list of one or more objects of the system to perform a predetermined workflow in a delivery of healthcare to the patient.
